(19) United States
(12) Patent Application Publication
(10) Pub. No.: US 2026/0046691 A1
(43) Pub. Date: Feb. 12, 2026

(54) METHOD AND DEVICE FOR DISCARDING RLC AM DATA IN MOBILE COMMUNICATION SYSTEM

(71) Applicant: SAMSUNG ELECTRONICS CO., LTD., Suwon-si (KR)

(72) Inventors: Weiping SUN, Suwon-si (KR); Hyunjeong KANG, Suwon-si (KR); Jaehyuk JANG, Suwon-si (KR)

(21) Appl. No.: 19/292,704

(22) Filed: Aug. 6, 2025

(30) Foreign Application Priority Data
Aug. 6, 2024 (KR) 10-2024-0104475

(51) Int. Cl. H04W 28/06; H04L 1/1607; H04W 8/22; H04W 76/20

(52) U.S. Cl. CPC H04W 28/06; H04L 1/1642; H04W 8/22; H04W 76/20

(57) ABSTRACT

The disclosure relates to a 5G or 6G communication system for supporting a higher data transmission rate. The disclosure provides a method and a device for discarding RLC AM data in a wireless communication system. The method of a terminal comprise: receiving, from a base station, a message comprising information on a timer for a radio link control (RLC) service data unit (SDU) discard at an RLC entity of the terminal; receiving, from the base station, an acknowledged mode (AM) data (AMD) protocol data unit (PDU) with a sequence number (SN) x; when an AMD PDU with a SN y lower than x is not received, starting the timer; and when the timer expires, discarding at least one AMD PDU from a buffer with a SN lower than x+1.

### CROSS-REFERENCE TO RELATED APPLICATION(S)

This application is based on and claims priority under 35 U.S. C. § 119 to Korean Patent Application No. 10-2024-0104475, filed on Aug. 6, 2024, in the Korean Intellectual Property Office, the disclosure of which is herein incorporated by reference in its entirety.

### BACKGROUND

### 1. Field

The disclosure relates to a method and a device for discarding radio link control acknowledged mode (RLC AM) data in a wireless communication system.

### 2. Description of Related Art

5^{th} generation (5G) mobile communication technologies define broad frequency bands such that high transmission rates and new services are possible, and can be implemented not only in “Sub 6 GHz” bands such as 3.5 GHz, but also in “Above 6 GHz” bands referred to as mmWave including 28 GHz and 39 GHz. In addition, it has been considered to implement 6G mobile communication technologies (referred to as Beyond 5G systems) in terahertz bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with eXtended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

The above information is presented as background information only to assist with an understanding of the disclosure. No determination has been made, and no assertion is made, as to whether any of the above might be applicable as prior art with regard to the disclosure.

### SUMMARY

An embodiment of the disclosure is to provide a method and a device for discarding RLC AM data in a wireless communication system in a mobile communication system.

The technical subjects pursued in the disclosure may not be limited to the above-mentioned technical subjects, and other technical subjects which are not mentioned herein may be clearly understood from the following description by those skilled in the art to which the disclosure pertains.

In accordance with an aspect of the disclosure, a method performed by a terminal in a wireless communication system is provided. The method comprises receiving, from a base station, a message comprising information on a timer for a radio link control (RLC) service data unit (SDU) discard at an RLC entity of the terminal; receiving, from the base station, an acknowledged mode (AM) data (AMD) protocol data unit (PDU) with sequence number (SN) x; in case that an AMD PDU with SN y lower than x is not received, starting the timer; and in case that the timer expires, discarding at least one AMD PDU in a buffer with SN lower than x+1.

In an embodiment, the method further comprises in case that the timer is running, determining whether all AMD PDU with SN lower than x is received; and in case that all AMD PDU with SN lower than x is received, stopping the timer and resetting the timer.

In an embodiment, the method further comprises in case that the timer expires and the at least one AMD PDU is discarded, triggering a status report.

In an embodiment, the starting the timer comprises: in case that x is greater than or equal to RX_Next_Highest, updating RX_Next_Highest to x+1; determining at least one of whether the RX_Next_Highest is greater than RX_Next+1, or whether the RX_Next_Highest is equal to the RX_Next+1 and there is at least one missing byte segment of a RLC SDU associated with SN=RX_Next before a last byte of all received segments of the RLC SDU; and in case that at least one of the RX_Next_Highest is greater than RX_Next+1, or the RX_Next_Highest is equal to the RX_Next+1 and there is at least one missing byte segment of a RLC SDU associated with SN=RX_Next before a last byte of all received segments of the RLC SDU, starting the timer.

In an embodiment, the RX_Next holds a value of an SN following a last in-sequence completely received RLC SDU.

In an embodiment, the RX_Next_Highest holds a value of an SN following an SN of an RLC SDU with a highest SN among received RLC SDUs.

In an embodiment, the method further comprises setting RX_Next_Discard_Trigger to the RX_Next_Highest.

In an embodiment, the RX_Next_Discard_Trigger holds a value of an SN following an SN of an RLC SDU which triggered the timer.

In an embodiment, the determining whether all AMD PDU with SN lower than x is received comprises: determining at least one of whether RX_Next_Discard_Trigger equals to RX_Next, or whether the RX_Next_Discard_Trigger equals to RX_Next+1 and there is no missing byte segment of an RLC SDU associated with an SN=RX_Next before a last byte of all received segments of the RLC SDU, or whether the RX_Next_Discard_Trigger falls outside of a receiving window and the RX_Next_Discard_Trigger is not equal to RX_Next+AM_Window_Size.

In an embodiment, AM_Window_Size is a receiving window size.

In an embodiment, the information on the timer is included in RLC configuration information.

In accordance with an aspect of the disclosure, a terminal in a wireless communication system is provided. The terminal comprises a transceiver; and a controller configured to: receive, from a base station via the transceiver, a message comprising information on a timer for a radio link control (RLC) service data unit (SDU) discard at an RLC entity of the terminal, receive, from the base station via the transceiver, an acknowledged mode (AM) data (AMD) protocol data unit (PDU) with sequence number (SN) x, in case that an AMD PDU with SN y lower than x is not received, start the timer, and in case that the timer expires, discard at least one AMD PDU in a buffer with SN lower than x+1.

An embodiment of the disclosure can provide a method and a device for discarding RLC AM data in a wireless communication system.

Advantageous effects obtainable from the disclosure may not be limited to the above-mentioned effects, and other effects which are not mentioned herein may be clearly understood from the following description by those skilled in the art to which the disclosure pertains.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 illustrates an example of a structure of an NR system according to an embodiment of the disclosure;

FIG. 2 illustrates an example of a radio protocol structure in an NR system according to an embodiment of the disclosure;

FIG. 3 illustrates an example of a procedure for establishing a connection with a network by a terminal according to an embodiment of the disclosure;

FIG. 4 illustrates an example of an RLC AM data discard operation according to an embodiment of the disclosure;

FIG. 5 illustrates an example of a format of an RLC STATUS PDU when the length of an RLC SN is 12 bits, according to an embodiment of the disclosure;

FIG. 6 illustrates an example of a format of an RLC STATUS PDU when the length of an RLC SN is 18 bits, according to an embodiment of the disclosure;

FIG. 7 illustrates an example of a structure of a UE according to an embodiment of the disclosure; and

FIG. 8 illustrates an example of a structure of a base station according to an embodiment of the disclosure.

### DETAILED DESCRIPTION

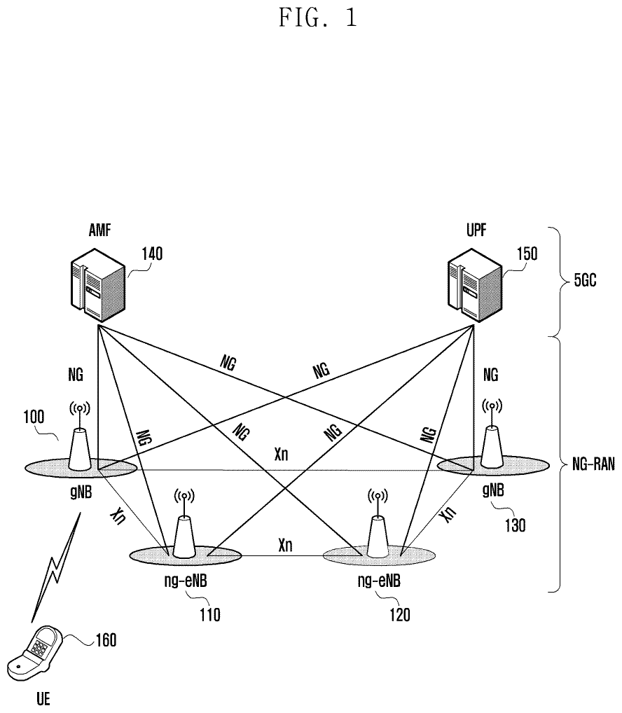

FIGS. 1 through 8, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

Hereinafter, the operation principle of the disclosure will be described in detail in conjunction with the accompanying drawings. In describing the disclosure below, a detailed description of known functions or configurations will be omitted when it is determined that the description may make the subject matter of the disclosure unnecessarily unclear. The terms which will be described below are terms defined in consideration of the functions in the disclosure, and may be different according to users, intentions of the users, or customs. Therefore, the definitions of the terms should be made based on the contents throughout the specification.

In describing the embodiments of the disclosure, descriptions related to technical contents well-known in the relevant art and not associated directly with the disclosure will be omitted. Such an omission of unnecessary descriptions is intended to prevent obscuring of the main idea of the disclosure and more clearly transfer the main idea.

For the same reason, in the accompanying drawings, some elements may be exaggerated, omitted, or schematically illustrated. Also, the size of each element does not completely reflect the actual size. In the respective drawings, the same or corresponding elements are assigned the same reference numerals.

The advantages and features of the disclosure and ways to achieve them will be apparent by making reference to embodiments as described below in detail in conjunction with the accompanying drawings. However, the disclosure is not limited to the embodiments set forth below, but may be implemented in various different forms. The following embodiments are provided only to completely disclose the disclosure and inform those skilled in the art of the scope of the disclosure, and the disclosure is defined only by the scope of the appended claims. Throughout the specification, the same or like reference signs indicate the same or like elements.

Herein, it will be understood that each block of the flowchart illustrations, and combinations of blocks in the flowchart illustrations, can be implemented by computer program instructions. These computer program instructions can be provided to a processor of a general-purpose computer, special purpose computer, or other programmable data processing apparatus to produce a machine, such that the instructions, which execute via the processor of the computer or other programmable data processing apparatus, create means for implementing the functions specified in the flowchart block or blocks. These computer program instructions may also be stored in a computer usable or computer-readable memory that can direct a computer or other programmable data processing apparatus to function in a particular manner, such that the instructions stored in the computer usable or computer-readable memory produce an article of manufacture including instruction means that implement the function specified in the flowchart block or blocks. The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified in the flowchart block or blocks.

Furthermore, each block in the flowchart illustrations may represent a module, segment, or portion of code, which includes one or more executable instructions for implementing the specified logical function(s). It should also be noted that in some alternative implementations, the functions noted in the blocks may occur out of the order. For example, two blocks shown in succession may in fact be executed substantially concurrently or the blocks may sometimes be executed in the reverse order, depending upon the functionality involved.

As used in embodiments of the disclosure, the term “unit” refers to a software element or a hardware element, such as a field programmable gate array (FPGA) or an application specific integrated circuit (ASIC), and the “unit” may perform certain functions. However, the “unit” does not always have a meaning limited to software or hardware. The “unit” may be constructed either to be stored in an addressable storage medium or to execute one or more processors. Therefore, the “unit” includes, for example, software elements, object-oriented software elements, class elements or task elements, processes, functions, properties, procedures, sub-routines, segments of a program code, drivers, firmware, micro-codes, circuits, data, database, data structures, tables, arrays, and parameters. The elements and functions provided by the “unit” may be either combined into a smaller number of elements, or a “unit,” or divided into a larger number of elements, or a “unit. ” Moreover, the elements and “units” may be implemented to reproduce one or more CPUs within a device or a security multimedia card.

In the following description, a base station is an entity that allocates resources to terminals, and may be at least one of a Node B, a base station (BS), an eNode B (eNB), a gNode B (gNB), a wireless access unit, a base station controller, and a node on a network. A terminal may include a user equipment (UE), a mobile station (MS), a cellular phone, a smartphone, a computer, or a multimedia system capable of performing a communication function. Furthermore, the embodiments of the disclosure as described below may also be applied to other communication systems having similar technical backgrounds or channel types to the embodiments of the disclosure. Moreover, based on determinations by those skilled in the art, the embodiments of the disclosure may also be applied to other communication systems through some modifications without significantly departing from the scope of the disclosure. Examples of such communication systems may include 5th generation mobile communication technologies (5G, new radio, and NR) developed beyond LTE-A, and in the following description, the “5G” may be the concept that covers the exiting LTE, LTE-A, and other similar services. In addition, based on determinations by those skilled in the art, the disclosure may also be applied to other communication systems through some modifications without significantly departing from the scope of the disclosure.

In the following description, terms for identifying access nodes, terms referring to network entities or network functions, terms referring to messages, terms referring to interfaces between network entities, terms referring to various identification information, and the like are illustratively used for the sake of descriptive convenience. Therefore, the disclosure is not limited by the terms as described below, and other terms referring to subjects having equivalent technical meanings may also be used.

In the following description, some of terms and names defined in the 3rd generation partnership project (3GPP) long term evolution (LTE) standards and/or 3GPP new radio (NR) standards may be used for the sake of descriptive convenience. However, the disclosure is not limited by these terms and names, and may be applied in the same way to systems that conform other standards.

FIG. 1 illustrates an example of a structure of an NR system according to an embodiment of the disclosure.

Referring to FIG. 1, a wireless communication system may include multiple base stations (for example, a gNB 100, an ng-eNB 110, an ng-eNB 120, and a gNB 130), an access and mobility management function (AMF) 140, and a user plane function (UPF) 150. Of course, the wireless communication system is not limited by the structure illustrated in FIG. 1, and may include a larger or smaller number of components than those in the structure illustrated in FIG. 1.

According to an embodiment of the disclosure, a user equipment (hereinafter UE or terminal) 160 may access an external network via the base stations 100, 110, 120, and 130 and the UPF 150.

In FIG. 1, the base stations 100, 110, 120, and 130 may provide radio access to UEs that access the network as cellular network access nodes. For example, in order to service users'traffic, the base stations 100, 110, 120, and 130 may collect state information of UEs 160, such as the UEs'buffer states, available transmission power states, and channel states, and perform scheduling accordingly, thereby supporting connections between the UEs and the core network (CN; in particular, CN in NR is referred to as “5GC”).

In FIG. 1, the gNBs 100 and 130 may control multiple cells and employ an adaptive modulation & coding (hereinafter referred to as AMC) scheme for determining a modulation scheme and a channel coding rate according to a channel state of a UE 160.

The core network is a device responsible for various control functions as well as a mobility management function for UEs 160, and may be connected to multiple base stations 100, 110, 120, and 130. Also, the 5GC may interwork with the LTE system.

A wireless communication system may include a user plane (UP) associated with actual user data transmission and a control plane (CP) such as connection management. In FIG. 1, the gNB 100 and gNB 130 may use UP and CP technology defined in the NR technology, and although connected to the 5GC, the ng-eNB 110 and ng-eNB 120 may use UP and CP technology defined in the long term evolution (LTE) technology.

The AMF 140 is a device responsible for various control functions as well as a mobility management function for a UE, and may be connected to multiple base stations 100, 110, 120k, and 130.

The UPF 150 may refer to a type of gateway device for providing data transmission. Although not illustrate in FIG. 1, the NR wireless communication system may include a session management function (SMF). The SMF may manage a packet data network connection such as a protocol data unit (PDU) session provided to the UE 160.

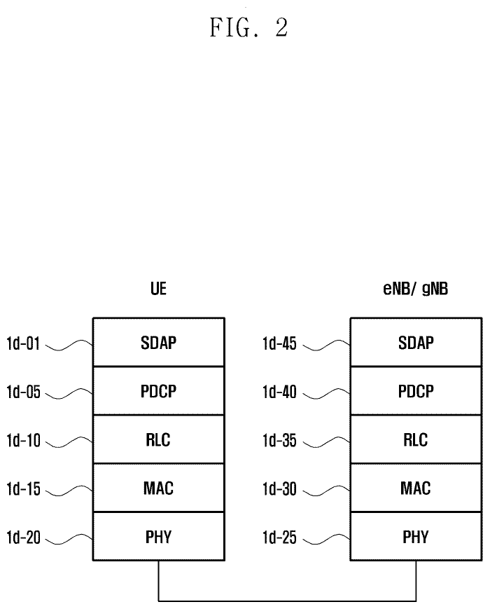

FIG. 2 illustrates an example of a radio protocol structure in an NR system according to an embodiment of the disclosure.

Referring to FIG. 2, a radio protocol of an NR system may include a service data adaptation protocol (SDAP) 200 or 290, a packet data convergence protocol (PDCP) 210 or 280, a radio link control (RLC) 220 or 270, a medium access control (MAC) 230 or 260, and physical (PHY) 240 or 250 on each of UE and base station sides.

The SDAP 200 or 290 may perform an operation for transferring user plane data, an operation for mapping between a QoS flow and a specific DRB for both uplink and downlink, and an operation for mapping a reflective QoS flow to a data bearer for uplink SDAP PDUs. An SDAP configuration corresponding to each DRB may be provided from a higher RRC layer. Obviously, the examples given above are not limiting.

The packet data convergence protocol (PDCP) 210 or 280 may be responsible for operations such as IP header compression/reconstruction. Also, the PDCP 210 or 280 may provide an in-sequence delivery function, an out-of-sequence delivery function, a reordering function, a retransmission function, and a ciphering and deciphering function. Obviously, the examples given above are not limiting.

The RLC 220 or 270 may reconfigure a PDCP protocol data unit (PDU) into appropriate sizes. Also, the RLC 220 or 270 may provide an in-sequence delivery function, an out-of-sequence delivery function, an automatic repeat request (ARQ) function, a concatenation, segmentation, and reassembly function, a re-segmentation function, a reordering function, a duplicate detection function, and an error detection function. Obviously, the examples given above are not limiting.

The MAC 230 or 260 may be connected to several RLC layer devices configured in a single UE, and perform operations of multiplexing RLC PDUs into an MAC PDU and demultiplexing RLC PDUs from an MAC PDU. Also, the MAC 230 or 260 may provide a mapping function, a scheduling information reporting function, an HARQ function, a priority handling function between logical channels, a priority handling function between UEs, an MBMS service identification function, a transport format selection function, and a padding function. Obviously, the examples given above are not limiting.

A physical (PHY) layer 240 or 250 may perform operations of channel-coding and modulating upper layer data, thereby obtaining OFDM symbols, and delivering the same through a radio channel, or demodulating OFDM symbols received through the radio channel, channel-decoding the same, and delivering the same to the upper layer. For additional error correction, the PHY layer also uses hybrid ARQ (HARQ), and a receiving end uses one bit to transmit whether a packet transmitted by a transmitting end is received. This 1-bit information is referred to as HARQ ACK/NACK information.

Downlink HARQ ACK/NACK information with regard to uplink data transmission may be transmitted via a physical ARQ indicator channel (PHICH), and in the case of NR, whether retransmission is performed or new transmission has only to be performed may be determined through UE scheduling information via a physical dedicated control channel (PDCCH) that is a channel via which downlink/uplink resource allocation and the like are transmitted. This is because asynchronous HARQ is applied in NR. Uplink HARQ ACK/NACK information in response to downlink data transmission may be transmitted through a physical uplink control channel (PUCCH) or through a physical uplink shared channel (PUSCH). The PUCCH is generally transmitted in an uplink of a PCell as described below, but if supported by a UE, a base station may also additionally transmit the same to the corresponding UE in an SCell as described below, which is referred to as a PUCCH SCell.

Although not illustrated in FIG. 2, a radio resource control (RRC) layer may exist as a higher layer than each PDCP layer of the UE and the base station, and the RRC layer may exchange access/measurement-related configuration control messages for radio resource control.

The PHY layer may include one or multiple frequencies/carriers, and a technology for simultaneously configuring and using multiple frequencies is referred to as carrier aggregation (hereinafter referred to as “CA”). The CA refers to a technology in which, instead of using only one carrier for communication between a UE and a base station (eNB or gNB), one primary carrier and multiple secondary carriers are additionally used and thus data capacity may be greatly increased as much as the number of secondary carriers. In LTE/NR, a cell in a base station, which uses the primary carrier, is referred to as a primary cell or PCell, and a cell in a base station, which uses the secondary subcarriers, is referred to as a secondary cell or SCell.

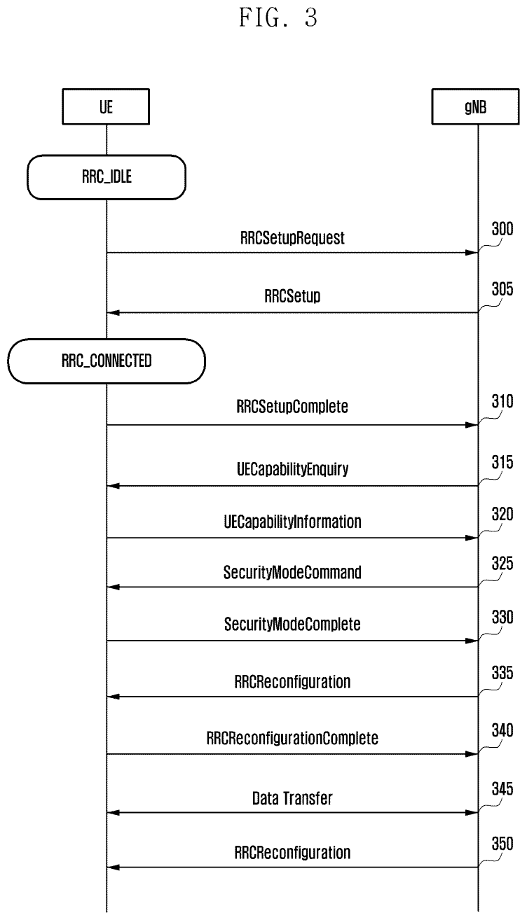

FIG. 3 illustrates an example of a procedure for establishing a connection with a network by a UE according to an embodiment of the disclosure.

In the disclosure, FIG. 3 describes a procedure in which a UE transitions from an RRC idle state/RRC idle mode (RRC_IDLE) to an RRC connected state/RRC connected mode (RRC_CONNECTED) and establishes a connection with a network.

Referring to FIG. 3, in step 300, a UE may establish uplink/downlink transmission synchronization with a base station through a random access process, and transmit an RRCSetupRequest message to the base station. The RRCSetupRequest message may include an identifier of the UE and a reason for establishing a connection (EstablishmentCause).

In step 305, the base station may transmit an RRCSetup message to the UE so that the UE establishes an RRC connection.

In an embodiment, the RRCSetup message may include configuration information (RadioBearerConfig) for each radio bearer (data radio bearer (DRB) or signaling radio bearer (SRB)). The radio bearer configuration information may include an ID of each radio bearer, configuration information (PDCP-Config) for a PDCP layer device of the corresponding radio bearer, an indicator indicating whether the corresponding radio bearer is a dual active protocol stack (DAPS) bearer, and the like.

In an embodiment, the RRCSetup message may include configuration information (e.g., CellGroupConfig) for each Cell Group (a Master Cell Group and/or a Secondary Cell Group). The Cell Group configuration information (CellGroupConfig) may include configuration information (e.g., RLC-BearerConfig) for each RLC bearer with respect to one or more RLC bearers to be configured for the corresponding Cell Group.

In an embodiment, the configuration information (RLC-BearerConfig) for each RLC bearer may include the following fields. The description for each field may be as follows:
logicalChannelIdentity: ID used commonly for the MAC logical channel and for the RLC bearer. Value 4 is not configured for DRBs if SRB4 is configured;
servedRadioBearer: Associates the RLC Bearer with an SRB or a DRB. The UE may deliver DL RLC SDUs received via the RLC entity of this RLC bearer to the PDCP entity of the servedRadioBearer. Furthermore, the UE may advertise and deliver uplink PDCP PDUs of the uplink PDCP entity of the servedRadioBearer to the uplink RLC entity of this RLC bearer unless the uplink scheduling restrictions (moreThanOneRLC in PDCP-Config and the restrictions in LogicalChannelConfig) forbid it to do so;
reestablishRLC: Indicates that RLC may be re-established. Network sets this to true at least whenever the security key used for the radio bearer associated with this RLC entity changes. For SRB2, multicast MRBs and DRBs, unless full configuration is used, it is also set to true during the resumption of the RRC connection or the first reconfiguration after reestablishment. For SRB1, when resuming an RRC connection, or at the first reconfiguration after RRC connection reestablishment, the network does not set this field to true. The network does not include this field if the RLC-BearerConfig IE is part of an RRCReconfiguration message within the LTM-Config IE;
rlc-Config: Determines the RLC mode (UM, AM) and provides corresponding parameters. RLC mode reconfiguration can only be performed by DRB/multicast MRB release/addition or full configuration. The network may configure rlc-Config-v1610 only when rlc-Config (without suffix) is set to am; and/or
mac-LogicalChannelConfig: It may include logical channel configuration information for the corresponding RLC bearer.

In an embodiment, the rlc-Config may include RLC layer device configuration information of an RLC bearer. For example, the rlc-Config may include the following fields. The description for each field may be as follows:
When an RLC layer device is configured to be in an acknowledged mode (AM):
▪ ul-AM-RLC configuration information: sn-FieldLength (sequence number length), t-PollRetransmit (Poll retransmission timer size), pollPDU (Poll trigger PDU count threshold), pollByte (Poll trigger byte threshold), maxRetxThreshold (maximum number of retransmissions), and
▪ dl-AM-RLC configuration information: sn-FieldLength (sequence number length), t-Reassembly (Reassembly timer size), t-StatusProhibit (Status PDU prohibit timer size);
When the RLC layer device is configured to be in an unacknowledged mode (UM) Bi-Directional mode:
▪ ul-UM-RLC configuration information: sn-FieldLength (sequence number length), and
▪ dl-UM-RLC configuration information: sn-FieldLength (sequence number length), t-Reassembly (Reassembly timer size);
When the RLC layer device is configured to be in a UM Uni-Directional-UL mode:
▪ ul-UM-RLC configuration information: sn-FieldLength (sequence number length); and/or
When the RLC layer device is configured to be in a UM Uni-Directional-DL mode:
▪ dl-UM-RLC configuration information: sn-FieldLength (sequence number length), t-Reassembly (Reassembly timer size).

The UE having established the RRC connection may enter an RRC_CONNECTED mode, and transmit an RRCSetupComplete message to the base station in step 310.

If the base station is not aware of UE capability for the UE that is currently establishing the connection or intends to identify the UE capability, the base station may transmit a message (e.g., UECapabilityEnquiry) inquiring about the UE capability to the UE in step 315. In step 320, the UE may transmit a message (e.g., UECapabilityInformation) reporting its capability to the base station.

In step 325, the base station may transmit a SecurityModeCommand message to the UE in order to configure security with the UE, and in step 330, the UE may transmit a SecurityModeComplete message to the base station.

When the security configuration is completed, the base station may transmit an RRCReconfiguration message to the UE in step 335.

In an embodiment, the RRCReconfiguration message may include configuration information (RadioBearerConfig) for each radio bearer (DRB or SRB). The radio bearer configuration information may include an ID of each radio bearer, configuration information (PDCP-Config) for a PDCP layer device of the corresponding radio bearer, an indicator indicating whether the corresponding radio bearer is a DAPS bearer, and the like.

In an embodiment, the RRCReconfiguration message may include configuration information (e.g., CellGroupConfig) for each Cell Group (Master Cell Group and/or Secondary Cell Group). The Cell Group configuration information (CellGroupConfig) may include configuration information (e.g., RLC-BearerConfig) for each RLC bearer for one or more RLC bearers to be configured for the corresponding Cell Group.

In an embodiment, the configuration information (RLC-BearerConfig) for each RLC bearer may include the following fields. The description for each field may be as follows:
logicalChannelIdentity: ID used commonly for the MAC logical channel and for the RLC bearer. Value 4 is not configured for DRBs if SRB4 is configured;
servedRadioBearer: Associates the RLC Bearer with an SRB or a DRB. The UE may deliver DL RLC SDUs received via the RLC entity of this RLC bearer to the PDCP entity of the servedRadioBearer. Furthermore, the UE may advertise and deliver uplink PDCP PDUs of the uplink PDCP entity of the servedRadioBearer to the uplink RLC entity of this RLC bearer unless the uplink scheduling restrictions (moreThanOneRLC in PDCP-Config and the restrictions in LogicalChannelConfig) forbid it to do so;
reestablishRLC: Indicates that RLC may be re-established. Network sets this to true at least whenever the security key used for the radio bearer associated with this RLC entity changes. For SRB2, multicast MRBs and DRBs, unless full configuration is used, it is also set to true during the resumption of the RRC connection or the first reconfiguration after reestablishment. For SRB1, when resuming an RRC connection, or at the first reconfiguration after RRC connection reestablishment, the network does not set this field to true. The network does not include this field if the RLC-BearerConfig IE is part of an RRCReconfiguration message within the LTM-Config IE;
rlc-Config: Determines the RLC mode (UM, AM) and provides corresponding parameters. RLC mode reconfiguration can only be performed by DRB/multicast MRB release/addition or full configuration. The network may configure rlc-Config-v1610 only when rlc-Config (without suffix) is set to am; and/or
mac-LogicalChannelConfig: It may include logical channel configuration information for the corresponding RLC bearer.

In an embodiment, the rlc-Config may include RLC layer device configuration information of an RLC bearer. For example, the rlc-Config may include the following fields. The description for each field may be as follows:
When an RLC layer device is configured to be in an acknowledged mode (AM):
▪ ul-AM-RLC configuration information: sn-FieldLength (sequence number length), t-PollRetransmit (Poll retransmission timer size), pollPDU (Poll trigger PDU count threshold), pollByte (Poll trigger byte threshold), maxRetxThreshold (maximum number of retransmissions), and/or
▪ dl-AM-RLC configuration information: sn-FieldLength (sequence number length), t-Reassembly (Reassembly timer size), t-StatusProhibit (Status PDU prohibit timer size);
When the RLC layer device is configured to be in an unacknowledged mode (UM) Bi-Directional mode:
▪ ul-UM-RLC configuration information: sn-FieldLength (sequence number length), and/or
▪ dl-UM-RLC configuration information: sn-FieldLength (sequence number length), t-Reassembly (Reassembly timer size);
When the RLC layer device is configured to be in a UM Uni-Directional-UL mode:
▪ ul-UM-RLC configuration information: sn-FieldLength (sequence number length); and/or
When the RLC layer device is configured to be in a UM Uni-Directional-DL mode:
▪ dl-UM-RLC configuration information: sn-FieldLength (sequence number length), t-Reassembly (Reassembly timer size).

As such, a general connection establishment process may mainly include three steps: RRC connection establishment, security configuration, and DRB configuration. The UE may transmit an RRCReconfigurationComplete message to the base station in step 340, and the UE and the base station may perform data transmission and reception in step 345.

In addition, the base station may transmit an RRCReconfiguration message to the UE in step 350 in order to newly configure, add, or change a configuration for the UE for a predetermined reason.

In an embodiment of an embodiment of the disclosure, the UE having received an RRC message (RRCReconfiguration) may configure each radio bearer according to a radio bearer configuration of the corresponding message, configure the corresponding PDCP layer device, and configure an RLC bearer/layer device having an association with each radio bearer/PDCP layer device, and then establish an association between the RLC layer device and the PDCP layer device. In an embodiment, one radio bearer may correspond to one PDCP layer device. In an embodiment, each PDCP layer device may be associated with one, two, three, four, six, or eight RLC layer devices, as follows:
A PDCP layer device of a split bearer may be associated with two uplink or two downlink UM RLC layer devices, four UM RLC layer devices (two downlinks and two uplinks), or two AM RLC layer devices;
An RB for which a PDCP duplication transmission function is configured may be associated with N UM RLC layer devices (all downlinks or all uplinks), 2×N UM RLC layer devices (N uplinks and N downlinks), or N AM RLC layer devices for the corresponding PDCP layer device. Here, N may be greater than or equal to 2, and less than or equal to 4;
A PDCP layer device of a DAPS bearer may be associated with two UM RLC layer devices (all uplinks or all downlinks, one for a source cell and the other one for a target cell), four UM RLC layer devices (an uplink and a downlink of the source cell and an uplink and a downlink of the target cell), or two AM RLC layer devices (one for the source cell and the other one for the target cell); and/or
In other cases, each PDCP layer device may be associated with one UM RLC layer device, two UM RLC layer devices (one for an uplink and one for a downlink), or one AM RLC layer device.

In an embodiment of the disclosure, an RLC layer device may operate in one of a transparent mode (TM), an unacknowledged mode (UM), or an acknowledged mode (AM). Therefore, the RLC layer device may be referred to as a TM RLC layer device, an UM RLC layer device, or an AM RLC layer device depending on a corresponding mode.

For example, the UM RLC layer device may operate as one of a transmitting UM RLC layer device (transmitting UM RLC entity) or a receiving UM RLC layer device (receiving UL RLC entity).

For example, one AM RLC layer device may be configured to include a transmitting side and a receiving side.

In an embodiment of the disclosure, each RLC SDU may be made into an RLC PDU without a transmission opportunity notification from a lower layer (e.g., MAC). According to an embodiment, the UM RLC layer device or the AM RLC layer device may divide one RLC SDU into two or more segments, based on the transmission opportunity notification from the lower layer, and transmit the segments as two or more RLC PDUs. For example, the RLC layer device may submit an RLC PDU to the lower layer after receiving a transmission opportunity notification from the lower layer.

In the disclosure, an RLC AM transmitting side may refer to a transmitting side of the AM RLC layer device. In the disclosure, an RLC AM receiving side may refer to a receiving side of the AM RLC layer device.

An embodiment of STATUS PDU reception operation:

In an embodiment of the disclosure, when an AM RLC transmitting side receives a STATUS PDU transmitted by a peer RLC layer device, the AM RLC transmitting side may operate as follows:
A positive acknowledgement (i.e., identifying that the peer RLC layer device has successfully received the PDU) for a specific RLC SDU may be received through a STATUS PDU; and/or
The AM RLC transmitting side having received a positive acknowledgement for an RLC SDU with a sequence number (SN) of x may indicate successful delivery of the corresponding RLC SDU to a higher layer (e.g., a PDCP layer).

The AM RLC transmitting side having received a positive acknowledgement for an RLC SDU with a sequence number (SN) of x may configure TX_Next_Ack as the smallest SN among SNs in the range TX_Next_Ack<=SN<=TX_Next for which a positive acknowledgement has not yet been received.
Through the STATUS PDU, the AM RLC transmitting side may receive a negative acknowledgement (a notification of failure to receive the corresponding RLC SDU by a peer AM RLC layer device) for a specific RLC SDU or specific RLC SDU segment. For example, the AM RLC transmitting side having received the negative acknowledgement for the specific RLC SDU or specific RLC SDU segment may operate as follows.
If an SN of the corresponding RLC SDU belongs to the range of TX_Next_Ack≤SN≤the highest SN among AM data (AMD) PDUs delivered to the lower layer, retransmission may be performed for the RLC SDU or RLC SDU segment for which the negative acknowledgement has been received.

An embodiment of performing RLC AM Retransmission:

In an embodiment of the disclosure, when retransmission is performed for a specific RLC SDU or RLC SDU segment, the AM RLC transmitting side may operate as follows.
If retransmission is performed for the corresponding RLC SDU or RLC SDU segment for the first time, an RETX_COUNT value of the corresponding RLC SDU may be configured to be 0.
Otherwise, if an RLC SDU or RLC SDU segment may be retransmitted is not yet in a pending state for retransmission, and RETX_COUNT of the corresponding RLC SDU has not yet been incremented by another negative acknowledgement in the same STATUS PDU:
The RETX_COUNT of the corresponding RLC SDU may be incremented by 1.
If the RETX_COUNT is equal to a specific threshold (e.g., maxRetxThreshold) configured by the base station:
A notification indicating that the maximum number of retransmissions has been reached may be provided to a higher layer (e.g., an RRC layer).
If necessary, the corresponding RLC SDU or RLC SDU segment may be segmented.
A new AMD PDU fitting within the total size of AMD PDU(s) indicated by a lower layer (e.g., a MAC layer) in a specific transmission opportunity may be formed (generated).
A new AMD PDU may be submitted to the lower layer (e.g., a MAC layer).

RLC AM retransmission problem:

Generally, an RLC transmitting side and a peer receiving side operating in an RLC AM mode may ensure no data loss in an RLC layer. However, if an RLC SDU which has not been successfully delivered is retransmitted until the RLC SDU is successfully delivered to ensure no data loss, a validity period of data included in the corresponding RLC SDU may be exceeded. For example, in the case of extended reality (XR) data, the data has a specific delay budget (e.g., PDU Delay Budget or PDU Set Delay Budget) due to quality of service (QoS) requirements, and if the corresponding delay budget is exceeded, the usability of the data may be reduced or disappear. The disclosure provides, as a method for reducing unnecessary retransmission occurring in an RLC AM mode, a method for stopping retransmission of an RLC SDU which has not yet been successfully received by an RLC AM receiving side if the RLC SDU satisfies a specific condition.

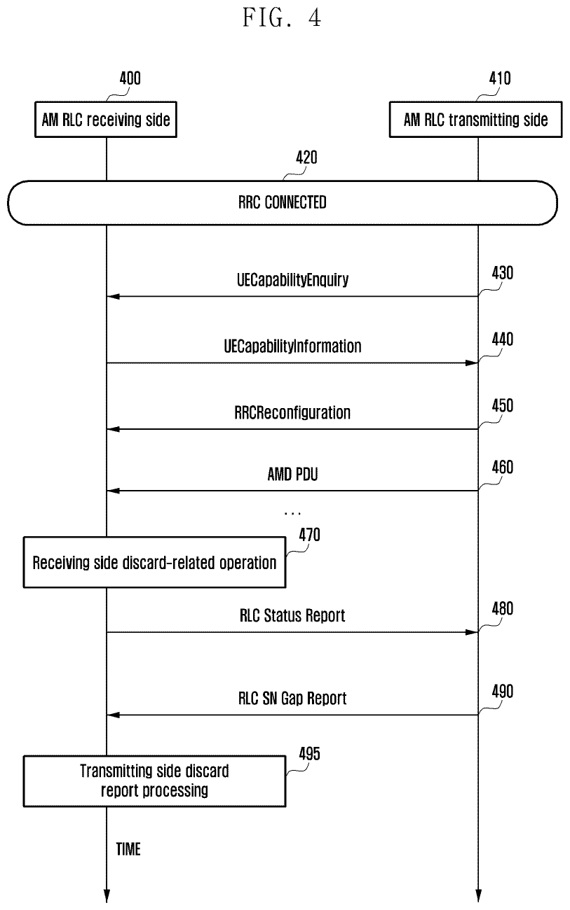

FIG. 4 illustrates an example of an RLC AM receiving side/transmitting side-based data discard operation according to an embodiment of the disclosure.

Referring to FIG. 4, an AM RLC receiving side 400 may be a base station or a UE. An AM RLC transmitting side 410 may be a UE or a base station. The following description exemplifies a case where the AM RLC receiving side 400 is a UE, and the AM RLC transmitting side 410 is a base station. However, this embodiment is not limited thereto, and may be similarly inferred and applied to a case in which the AM RLC receiving side 400 is a base station and the AM RLC transmitting side 410 is a UE.

Referring to FIG. 4, the base station (RLC AM transmitting side) 410 may transmit a UE capability request (UECapabilityEnquiry) message requesting a capability report to the UE (RLC AM receiving side) 400 in an RRC connected (RRC_CONNECTED) state 420 in step 430. The base station 410 may include a UE capability request for each RAT type in the UECapabilityEnquiry message. For example, when the base station 410 requests the UE 400 to generate a UECapabilityInformation message through the capability request message, the base station may include filtering information capable of indicating conditions and restrictions. For example, the filtering information may include frequency band list information requesting capability reporting for each RAT type. For example, the filtering information may indicate whether the UE 400 may report whether a specific function is supported for each RAT type. For example, the filtering information may indicate whether the UE 400 may report whether an RLC AM transmitting side and/or receiving side-based data discard function provided in the disclosure is supported for a specific RAT type (e.g., NR).

The UE 400 may configure a UE capability information (UECapabilityInformation) message corresponding to the UECapabilityEnquiry message, and report the message to the base station in response to the request in step 440.

In the UECapabilityInformation message, the UE 400 may include a field indicating whether the UE 400 supports an RLC AM receiving side and/or transmitting side data discard function provided in the disclosure. For example, the field may be represented as 1-bit information (e.g., 1: supported, 0: not supported). For another example, if the field is included in the UECapabilityInformation message, the field may indicate that the UE 400 supports the corresponding function, and if the field is not included, the field may indicate that the UE 400 does not support the corresponding function.

The base station 410 may determine whether the UE 400 supports an RLC AM discard function provided in the disclosure, through the UECapabilityInformation message transmitted by the UE 400.

For example, when the base station 410 determines that the UE 400 supports the RLC AM receiving side and/or transmitting side data discard function provided in the disclosure, the base station 410 may transmit an RRCReconfiguration message in step 450. The RRCReconfiguration message may include RLC AM receiving side and/or transmitting side data discard-related configuration information in the corresponding RLC layer device configuration information (e.g., rlc-Config) when the corresponding RLC layer device operates in an RLC AM mode, in RLC bearer-specific configuration information (RLC-BearerConfig). For example, the RLC AM receiving side and/or transmitting side data discard-related configuration information may include at least one piece of the following information.
Whether to enable (activate) an RLC AM receiving side and/or transmitting side data discard operation at the corresponding RLC layer device may be configured. The configuration information (e.g., rlcAmRxDiscard (receiving side) and/or rlcAmTxDiscard (transmitting side)) may be represented as 1-bit information (e.g., 1: enabled, 0: disabled). For another example, the configuration information (e.g., rlcAmRxDiscard/rlcAmTxDiscard) may indicate that the corresponding function is enabled if a specific field (e.g., rlcAmRxDiscard/rlcAmTxDiscard) is included in the message, and may indicate that the corresponding function is not enabled if the corresponding field is not included.

In step 460, the base station 410 may transmit an AMD PDU to the UE 400.

In the disclosure, a discarded RLC AM SDU may indicate an RLC SDU for which the RLC AM transmitting side 410 has not yet received a positive acknowledgment from the peer RLC AM receiving side 400 for the corresponding RLC SDU, but has determined not to perform retransmission any longer.

In this disclosure, a discarded RLC AM SDU may indicate an RLC SDU for which the RLC AM receiving side 400 has not yet successfully received the corresponding RLC SDU from the peer RLC AM transmitting side 410, but has determined not to receive the corresponding RLC SDU any longer. For example, the receiving side 400 may transmit a positive acknowledgment for the corresponding RLC SDU to the transmitting side 410 through an RLC STATUS PDU, thereby preventing the transmitting side 410 from (re)transmitting the corresponding RLC SDU any longer.

Although the disclosure is expressed as a discarded RLC (AM) SDU, this is only an example, and the disclosure does not limit the expression.

If the RLC AM receiving side data discard operation is enabled (e.g., if rlcAmRxDiscard is configured), the AM RLC receiving side 400 may perform an RLC AM receiving side discard-related operation in step 470. For example, when it is determined to discard specific RLC SDU(s) through the RLC AM receiving side data discard-related operation, the RLC AM receiving side 400 may trigger an RLC STATUS report/PDU in step 480.

In an embodiment of the disclosure, in step 480, the RLC AM receiving side 400 may report, to the RLC AM transmitting side 410, through the RLC STATUS PDU/report, a positive acknowledgement for an RLC SDU and/or RLC SDU segment determined to be discarded (that is, to prevent retransmission of the corresponding RLC SDU/SDU segment although the peer RLC layer device 400 has not successfully received the corresponding RLC SDU/RLC SDU segment).

In an embodiment of the disclosure, the AM RLC layer device 400 may generate a STATUS PDU as follows:
For an RLC SDU having an SN in the range of RX_Next<=SN<RX_Highest_Status, which has not yet been completely received and has not been discarded, the AM RLC layer device may perform the following operation starting from SN=RX_Next, in ascending order of SNs of RLC SDUs and in ascending order of byte segments within the RLC SDU, until the size of a STATUS PDU can be accommodated within the total size of RLC PDU(s) indicated by a lower layer;
For an RLC SDU for which a byte segment has not yet been received and which has not been discarded, a NACK_CN corresponding to the SN of the corresponding RLC SDU may be included in the STATUS PDU;
For an RLC SDU which includes partially received byte segments of a consecutive sequence, has not yet been completely received, and has not been discarded, a corresponding set of NACK_SN, SOstart, and SOend may be added to the STATUS PDU;
For an RLC SDU which has not yet been discarded and has not been received as a consecutive sequence, a corresponding NACK_SN and NACK range set may be added to the STATUS PDU. If necessary, a SOstart and SOend pair may be added to the STATUS PDU; and/or
An ACK_SN may be configured as an SN of the next RLC SDU which has not yet been discarded and has not been received, and is not indicated as missing in the final STATUS PDU.

An embodiment of receiving an RLC AMD PDU:

In an embodiment of the disclosure, when an AMD PDU with SN=x is placed in a reception buffer, the receiving side 400 of the AM RLC layer device may operate as follows:
If x>=RX_Next_Highest:
   RX_Next_Highest may be updated to x+1.
If all bytes of an RLC SDU with SN=x have been received:
   An RLC SDU may be reassembled from AMD PDU(s) with SN=x, an RLC header may be removed, and the reassembled RLC SDU may be delivered to a higher layer.
   If x=RX_Highest_Status:
      RX_Highest_Status may be updated to an SN of a first RLC SDU for which not all bytes have yet been received and which satisfies SN>current RX_Highest_Status.
   If x=RX_Next:
      RX_Next may be updated to an SN of a first RLC SDU for which not all bytes have yet been received and which satisfies SN>current RX_Next.
If t-Reassembly is running:
   If RX_Next_Status_Trigger=RX_Next; or
   If RX_Next_Status_Trigger=RX_Next+1, and there is no missing byte segment before the last byte of all received segments of an SDU associated with SN=RX_Next; or
   If RX_Next_Status_Trigger falls outside a receiving window and RX_Next_Status_Trigger is not equal to RX_Next+AM_Window_Size:
      t-Reassembly may be stopped and reset.
If t-Reassembly is not running (including a case where t-Reassembly is stopped due to the operation):
   If RX_Next_Highest>RX_Next+1; or
   If RX_Next_Highest=RX_Next+1, and there is at least one missing byte segment before the last byte of all received segments of an SDU associated with SN=RX_Next:
      t-Reassembly may be started.
RX_Next_Status_Trigger may be configured to RX_Next_Highest.

In an embodiment of the disclosure, the RLC AM receiving side discard-related operation 470 may be performed based on a t-Reassembly timer. For example, when the t-Reassembly timer expires, the RLC AM receiving side 400 may update a state variable, start the t-Reassembly timer, and perform a discard operation for a specific RLC SDU/RLC SDU segment.

An embodiment of a t-Reassembly-based receiving side data discard operation:

In an embodiment of the disclosure, when t-Reassembly expires, the receiving side 400 of the AM RLC layer device may operate as follows:
If rlcAmRxDiscard (receiving side-based data discard) is configured:
   RX_Next may be updated to an SN of a first RLC SDU for which not all bytes have yet been received and which satisfies SN>current RX_Next.
   All RLC SDUs/RLC SDU segment(s) having an SN smaller than the updated RX_Next may be discarded.
   If RX_Next_Highest>RX_Next+1; or
   If RX_Next_Highest=RX_Next+1, and there is at least one missing byte segment before the last byte of all received segments of an SDU associated with SN=RX_Next:
      t-Reassembly may be started.
      RX_Next_Status_Trigger may be configured to RX_Next_Highest.
   RX_Highest_Status may be updated to an SN of a first RLC SDU for which not all bytes have yet been received and which satisfies SN>=RX_Next_Status_Trigger.
If rlcAmRxDiscard (receiving side-based data discard) is not configured:
   RX_Highest_Status may be updated to an SN of a first RLC SDU for which not all bytes have yet been received and which satisfies SN>=RX_Next_Status_Trigger.
   If RX_Next_Highest>RX_Highest_Status+1: or
   If RX_Next_Highest=RX_Highest_Status+1, and there is at least one missing byte segment before the last byte of all received segments of an SDU associated with SN=RX_Highest_Status:
      t-Reassembly may be started.
      RX_Next_Status_Trigger may be configured to RX_Next_Highest.

An embodiment of t-Reassembly-based receiving side data discard:

In an embodiment of the disclosure, when t-Reassembly expires, the receiving side 400 of the AM RLC layer device may operate as follows.
If rlcAmRxDiscard is configured:
   RX_Next may be updated to an SN of a first RLC SDU for which not all bytes have yet been received and which satisfies SN>=RX_Next_Status_Trigger or RX_Highest_Status.
   All RLC SDUs/RLC SDU segment(s) having an SN smaller than the updated RX_Next may be discarded.
   If RX_Next_Highest>RX_Next+1; or
   If RX_Next_Highest=RX_Next+1, and there is at least one missing byte segment before the last byte of all received segments of an SDU associated with SN=RX_Next:
      t-Reassembly may be started.
      RX_Next_Status_Trigger may be configured to RX_Next_Highest.
   For example, RX_Highest_Status may be updated to an SN of a first RLC SDU for which not all bytes have yet been received and which satisfies SN>=RX_Next_Status_Trigger.
If rlcAmRxDiscard is not configured:
   RX_Highest_Status may be updated to an SN of a first RLC SDU for which not all bytes have yet been received and which satisfies SN>=RX_Next_Status_Trigger.
   If RX_Next_Highest>RX_Highest_Status+1: or
   If RX_Next_Highest=RX_Highest_Status+1, and there is at least one missing byte segment before the last byte of all received segments of an SDU associated with SN=RX_Highest_Status:
      t-Reassembly may be started.
      RX_Next_Status_Trigger may be configured to RX_Next_Highest.

In an embodiment of the disclosure, a specific RLC SDU discard timer (e.g., t-rlcAmDiscardTimer) is newly introduced, and the RLC AM receiving side-based data discard operation in step 470 may be performed based on the corresponding timer. For example, when the base station 410 determines that the UE 400 supports the RLC AM receiving side-based data discard function provided in the disclosure, in step 450, through the RRCReconfiguration message, in RLC bearer-specific configuration information (RLC-BearerConfig), the base station 410 may include RLC AM (receiving side) data discard-related configuration information in the corresponding RLC layer device configuration information (e.g., rlc-Config) and configure the information for the UE 400 when the corresponding RLC layer device operates in an RLC AM mode. For example, RLC AM receiving side data discard-related configuration information may include a configuration value for the t-rlcAmDiscardTimer timer. For example, the configuration value for the t-rlcAmDiscardTimer timer may be limited to the same value as a configuration value of a t-Reordering timer of a PDCP layer device or to a value having a specific offset. For example, a configuration value for the t-rlcAmDiscardTimer timer may be configured as an integer multiple of a configuration value of the t-Reassembly timer of the corresponding RLC layer device. For example, the base station may only configure the t-rlcAmDiscardTimer as a multiple of the t-Reassembly. Alternatively, the t-rlcAmDiscardTimer may be configured in a manner of indicating, through a specific field having a time unit, how much greater or smaller the t-rlcAmDiscardTimer is than the t-Reassembly.

For example, a t-rlcAmDiscardTimer state variable (e.g., RX_Next_Discard_Trigger) may be newly introduced. The state variable may indicate the following information.
It may hold a value of an SN following an SN of an RLC SDU which triggered the t-rlcAmDiscardTimer.

An embodiment of an RLC AMD PDU reception operation:

In an embodiment of the disclosure, when an AMD PDU with SN=x is placed in a reception buffer, the receiving side 400 of the AM RLC layer entity may operate as follows.
If x>=RX_Next_Highest:
   RX_Next_Highest may be updated to x+1.
If all bytes of an RLC SDU with SN=x are received:
   An RLC SDU may be reassembled from AMD PDU(s) with SN=x, an RLC header may be removed, and the reassembled RLC SDU may be delivered to a higher layer.
If x=RX_Highest_Status:
   RX_Highest_Status may be updated to an SN of a first RLC SDU with SN>current RX_Highest_Status for which not all bytes have been received.
If x=RX_Next:
   RX_Next may be updated to an SN of a first RLC SDU with SN>current RX_Next for which not all bytes have been received.
If rlcAmRxDiscard is configured:
   If t-rlcAmDiscardTimer is running:
      If RX_Next_Discard_Trigger=RX_Next; or
      If RX_Next_Discard_Trigger=RX_Next+1, and there is no missing byte segment of an SDU associated with SN=RX_Next before the last byte of all received segments of this SDU; or
      If RX_Next_Discard_Trigger falls outside a receiving window and RX_Next_Discard_Trigger is not equal to RX_Next+AM_Window_Size:
         t-rlcAmDiscardTimer may be stopped and reset.
   If t-rlcAmDiscardTimer is not running (including a case where t-rlcAmDiscardTimer is stopped due to the actions above):
      If RX_Next_Highest>RX_Next+1; or
      If RX_Next_Highest=RX_Next+1, and there is at least one missing byte segment of an SDU associated with SN=RX_Next before the last byte of all received segments of this:
         t-rlcamdiscardTimer may be started.
         RX_Next_Discard_Trigger may be set to RX_Next_Highest.

For example, when an AMD PDU with SN=k+2 is placed in the reception buffer in a situation where RX_Next (i.e., an SN of an AMD PDU may be received next) is k, the receiving side 400 of the AM RLC layer device may update RX_Next_Highest to k+3. Further, the receiving side 400 may determine whether all AMD PDUs with SNs smaller than k+2 have been received. In this case, since an AMD PDU with SN=k has not yet been received, RX_Next may be maintained as k.

For example, since RX_Next is k, and thus RX_Next_Highest>RX_Next+1 (i.e., k+3>k+1), the receiving side 400 may start t-rlcAmDiscardTimer. Further, RX_Next_Discard_Trigger may be configured to k+3 which is RX_Next_Highest.

Alternatively, for example, when the AMD PDU with SN=k is received before starting the t-rlcAmDiscardTimer, RX_Next may be updated to k+1. Since RX_Next is k+1, and thus RX_Next_Highest>RX_Next+1 (i.e., k+3>k+2), the receiving side 400 may start the t-rlcAmDiscardTimer. Further, RX_Next_Discard_Trigger may be configured to k+3 which is RX_Next_Highest.

Alternatively, for example, when a segment of the AMD PDU with SN=k+2 is received in a situation where RX_Next is k+2, RX_Next_Highest may be updated to k+3. In this case, since not all SDU segments of the AMD PDU with SN=k+2 have been received, RX_Next may be maintained as k+2. Further, when there is at least one missing byte segment before the last byte of all received segments of an SDU associated with SN=k+2, for example, there may be three segments of the SDU with SN=k+2 and only the last segment among the segments may be received. In this case, RX_Next_Highest=RX_Next+1 (i.e., k+3=k+3), and there is at least one missing byte segment before the last byte of all received segments associated with SN=k+2, the receiving side 400 may start the t-rlcAmDiscardTimer. Further, RX_Next_Discard_Trigger may be configured to k+3 which is RX_Next_Highest.

While the t-rlcAmDiscardTimer is running, the receiving side 400 of the AM RLC layer device may determine whether all the missing AMD PDUs have been received. When all the missing AMD PDUs have been received, the receiving side 400 of the AM RLC layer device may stop and reset the t-rlcAmDiscardTimer.

For example, when RX_Next_Discard_Trigger is k+3, there may be a case where t-rlcAmDiscardTimer is started in a situation where RX_Next is k. While the t-rlcAmDiscardTimer is running, the receiving side 400 of the AM RLC layer device may receive AMD PDUs with SN=k and SN=k+1. In this case, since AMD PDUs have been received up to SN=k+2 (since the t-rlcAmDiscardTimer has been started by the reception of the AMD PDU with SN=k+2), RX_Next may be updated to k+3. In this case, since RX_Next_Discard_Trigger=RX_Next (i.e., k+3=k+3), the receiving side 400 may stop and reset the t-rlcAmDiscardTimer.

Alternatively, for example, there may be a case where a segment of the AMD PDU with SN=k+2 is received in a situation where RX_Next is k+2, and thus the t-rlcAmDiscardTimer is started. While the t-rlcAmDiscardTimer is running, there may be no missing byte segment before the last byte of all received segments of the SDU associated with SN=k+2 at the receiving side 400 of the AM RLC layer device. That is, when there are three segments of the SDU associated with SN=k+2, and only the last segment among the segments is received and thus the t-rlcAmDiscardTimer is started, and then all segments of the SDU associated with SN=k+2 are received, the receiving side 400 may stop and reset the t-rlcAmDiscardTimer.

Alternatively, when RX_Next_Discard_Trigger falls outside a receiving window and RX_Next_Discard_Trigger is not equal to RX_Next+AM_Window_Size, the receiving side 400 may stop and reset the t-rlcAmDiscardTimer.

An embodiment of t-rlcAmDiscardTimer-based receiving side data discard:

In an embodiment of the disclosure, when t-rlcAmDiscardTimer expires, the receiving side 400 of the AM RLC layer device may operate as follows as an embodiment of an RLC SDU discard operation.
If rlcAmRxDiscard is configured:
   RX_Next may be updated to an SN of a first RLC SDU for which not all bytes have yet been received and which satisfies SN>current RX_Next.
   All RLC SDUs/RLC SDU segment(s) having an SN smaller than the updated RX_Next may be discarded.
   If RX_Next_Highest>RX_Next+1; or
   If RX_Next_Highest=RX_Next+1, and there is at least one missing byte segment before the last byte of all received segments of an SDU associated with SN=RX_Next:
      t-rlcAmDiscardTimer May Be Started.
      RX_Next_Discard_Trigger may be configured to RX_Next_Highest.

An embodiment of t-rlcAmDiscardTimer-based receiving side data discard:

In an embodiment of the disclosure, when t-rlcAmDiscardTimer expires, the receiving side 400 of the AM RLC layer device may operate as follows as an embodiment of an RLC SDU discard operation.
If rlcAmRxDiscard is configured:
   RX_Next may be updated to an SN of a first RLC SDU for which not all bytes have yet been received and which satisfies SN>=RX_Next_Status_Trigger/RX_Highest_Status/RX_Next_Discard_Trigger.
   All RLC SDUs/RLC SDU segment(s) having an SN lower than the updated RX_Next may be discarded.
   If RX_Next_Highest>RX_Next+1; or
   If RX_Next_Highest=RX_Next+1, and there is at least one missing byte segment of an SDU associated with SN=RX_Next before the last byte of all received segments of this SDU:
      t-rlcAmDiscardTimer may be started.
      RX_Next_Discard_Trigger may be set to RX_Next_Highest.

For example, when RX_Next_Discard_Trigger is k+3 (i.e., when an AMD PDU with SN=k+2 is received), there may be a case where the t-rlcAmDiscardTimer is started in a situation where RX_Next is k. In this case, when the t-rlcAmDiscardTimer expires, the receiving side 400 of the AM RLC layer device may update RX_Next to k+3 which is RX_Next_Discard_Trigger. Further, the receiving side 400 may discard an RLC SDU/RLC SDU segment (an AMD PDU stored in a buffer) having an SN smaller than the updated RX_Next (which has the same value as RX_Next_Discard_Trigger) (i.e., k+3). Thereafter, the receiving side may perform an operation of determining whether to start the t-rlcAmDiscardTimer.

In an embodiment of the disclosure, the receiving side 400 of the RLC AM layer device may perform a receiving-side data discard-related operation when a t-Reordering timer of a higher layer (e.g., PDCP layer) device expires (470). For example, the PDCP layer device may operate as follows.
When the t-Reordering timer expires, a receiving PDCP layer device may operate as follows:
   If decompression has not been performed previously, after header decompression is performed, the following PDCP SDU(s) may be delivered to a higher layer in ascending order of their associated COUNT values.
      All stored PDCP SDU(s) having associated COUNT values<RX_REORD.
      All stored PDCP SDU(s) having consecutively associated COUNT values starting from RX_REORD. The consecutively associated COUNT value(s) may include all COUNT value(s) of PDCP SDU(s) which are considered discarded, based on the stored PDCP SDU(s) and TS 38.323 Clause 5.16.2.
   Among PDCP SDUs which satisfy COUNT value>=RX_REORD, RX_DELIV may be updated to a COUNT value of a first PDCP SDU which has not been delivered to the higher layer and is not considered discarded based on TS 38.323 Clause 5.16.2. For example, when a lower RLC layer device is in an RLC AM mode, when rlcAmRxDiscard (RLC AM receiving side data discard) is configured, and/or when the base station is configured to notify the lower layer of t-Reordering timer expiration when the t-Reordering timer expires, the PDCP layer device may notify a lower layer (e.g., RLC layer) device of the newly updated RX_DELIV value, an SN value of an RLC SDU corresponding to the newly updated RX_DELIV value, and/or the fact that the t-Reordering timer has expired.
   If RX_DELIV<RX_NEXT:
      RX_REORD may be updated to RX_NEXT.
      The t-Reordering timer may be started.

An embodiment of receiving side data discard:

In an embodiment of the disclosure, the receiving side 400 of the AM RLC layer device, which has been notified by a higher layer (PDCP layer) of the fact that the t-Reordering timer has expired and/or an SN value (e.g., RX_DELIV_NEXT) of an RLC SDU corresponding to the newly updated RX_DELIV, may operate as follows.
RX_Next may be updated to an SN of a first RLC SDU for which not all bytes have yet been received and which satisfies SN>RX_DELIV_NEXT.
All RLC SDUs/RLC SDU segment(s) having an SN smaller than the updated RX_Next may be discarded.

An embodiment of receiving side data discard:

In an embodiment of the disclosure, a receiving PDCP layer device which has received a PDCP SN Gap Report may operate as follows.
Each PDCP SDU, in which a bit of a discard bitmap is configured to “1” or an associated COUNT value is equal to a value of a first discarded COUNT (FDC) field, may be considered discarded.
An SN of an RLC SDU corresponding to each PDCP SDU considered discarded may be notified to the lower layer (RLC layer).

The RLC AM receiving side 400, which has been notified by the higher layer (PDCP layer) of the discarded PDCP SDU and/or an SN of a corresponding RLC SDU, may operate as follows.
The notified RLC SDU/RLC SDU segment(s) (corresponding to the discarded PDCP SDU) may be discarded.

In an embodiment of the disclosure, the base station 410 may indicate enabling/disabling of RLC AM transmitting side-based data discard and/or RLC AM receiving side-based data discard for each RLC AM layer device/each logical channel (LCH)/each DRB of the UE 400 through a specific MAC CE. For example, a specific RLC AM layer device of the UE 400 may perform an RLC AM transmitting side/receiving side data discard operation only when RLC AM transmitting side/receiving side data discard is enabled for a corresponding RLC AM layer device, an LCH corresponding to the corresponding RLC AM layer, or a DRB associated with the corresponding RLC AM layer device.

In an embodiment of the disclosure, the specific RLC AM layer device of the UE 400 may perform an RLC transmitting side/receiving side data discard operation only for a PDU set importance (PSI)-based low importance PDU Set.

In an embodiment of the disclosure, the RLC AM receiving side 400, for which RLC AM transmitting side-based data discard is configured to be able to transmit/receive an RLC SN Gap Report, may receive a report on RLC SDU discard for one or more SNs by receiving an RLC SN Gap Report/PDU from the peer RLC transmission device 410 in step 490. For example, the RLC reception device 400 which has received the RLC SN Gap report/PDU may process an RLC AM transmitting side data discard report (RLC SN Gap Report) as follows in step 495.
If an SN of an RLC SDU reported as RLC SN Gap/discard is outside of the receiving window, the RLC SN Gap/discard report for the corresponding RLC SDU may be ignored.
If all bytes of an RLC SDU reported as RLC SN Gap/discard have already been successfully received and/or the corresponding RLC SDU has already been delivered to the higher layer, the RLC SN Gap/discard report of the RLC SDU may be ignored.
If some byte segment(s) of an RLC SDU reported as RLC SN Gap/discard have already been received, the already received byte segment(s) may be discarded (from a reception buffer). In another embodiment, the corresponding byte segment(s) may be delivered to the higher layer.
When the highest SN value among RLC SDUs reported as discard/RLC SN gap in the RLC SN Gap report is indicated as Xmax:
▪ If Xmax is>=RX_Next_Highest:
♦ RX_Next_Highest may be updated to Xmax+1.
If RX_Highest_Status is reported as discard/RLC SN Gap:
▪ update RX_Highest_Status to the SN of the first RLC SDU with SN>current RX_Highest_Status for which not all bytes have been received, and has not been discarded.
if RX_Next is reported as discarded/RLC SN Gap:
▪ update RX_Next to the SN of the first RLC SDU with SN>current RX_Next for which not all bytes have been received, and has not been discarded.
if t-Reassembly is running:
▪ if RX_Next_Status_Trigger=RX_Next; or
▪ if RX_Next_Status_Trigger=RX_Next+1 and there is no missing byte segment of the SDU associated with SN=RX_Next before the last byte of all received segments of this SDU; or
▪ if RX_Next_Status_Trigger falls outside of the receiving window and RX_Next_Status_Trigger is not equal to RX_Next+AM_Window_Size:
♦ stop and reset t-Reassembly.
if t-Reassembly is not running (includes the case t-Reassembly is stopped due to actions above):
▪ if RX_Next_Highest>RX_Next+1; or
▪ if RX_Next_Highest=RX_Next+1 and there is at least one missing byte segment of the SDU associated with SN=RX_Next before the last byte of all received segments of this SDU:
♦ Start T-reassembly;
♦ set RX_Next_Status_Trigger to RX_Next_Highest.

In an embodiment of the disclosure, the RLC receiving device 400 configured to be able to transmit/receive an RLC SN Gap Report may operate as follows.

When t-Reassembly expires, the receiving side of an AM RLC entity may:
update RX_Highest_Status to the SN of the first RLC SDU with SN>=RX_Next_Status_Trigger for which not all bytes have been received and that has not been discarded;
if RX_Next_Highest>RX_Highest_Status+1: or
if RX_Next_Highest=RX_Highest_Status+1 and there is at least one missing byte segment of the SDU associated with SN=RX_Highest_Status before the last byte of all received segments of this SDU:
▪ start t-Reassembly;
▪ set RX_Next_Status_Trigger to RX_Next_Highest

In an embodiment of the disclosure, an AM RLC entity configured to be able to transmit/receive an RLC SN Gap Report may operate as follows.

When constructing a STATUS PDU, the AM RLC entity may:
for the RLC SDUs with SN such that RX_Next<=SN<RX_Highest_Status that has not been completely received yet and has not been discarded, in increasing SN order of RLC SDUs and increasing byte segment order within RLC SDUs, starting with SN=RX_Next up to the point where the resulting STATUS PDU still fits to the total size of RLC PDU(s) indicated by lower layer:
▪ for an RLC SDU for which no byte segments have been received yet and that has not been discarded:
♦ include in the STATUS PDU a NACK_SN which is set to the SN of the RLC SDU.
▪ for a continuous sequence of byte segments of a partly received RLC SDU that have not been received yet and that has not been discarded:
♦ include in the STATUS PDU a set of NACK_SN, SOstart and SOend.
▪ for a continuous sequence of RLC SDUs that have not been received yet and that has not been discarded:
♦ include in the STATUS PDU a set of NACK_SN and NACK range;
♦ include in the STATUS PDU, if necessary, a pair of SOstart and SOend.
▪ set the ACK_SN to the SN of the next not received RLC SDU which is not indicated as missing in the resulting STATUS PDU and that has not been discarded.

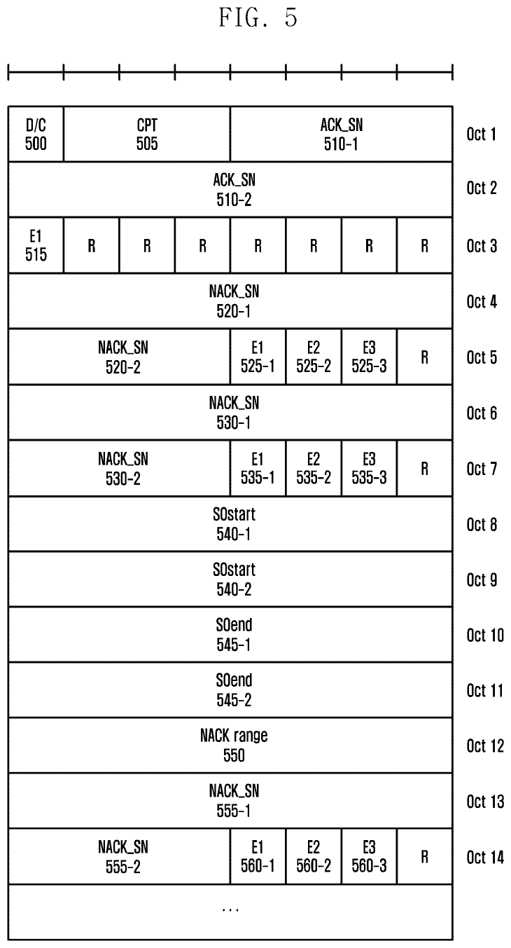

FIG. 5 illustrates an example of a format of an RLC STATUS PDU when the length of an RLC sequence number (SN) is 12 bits, according to an embodiment of the disclosure.

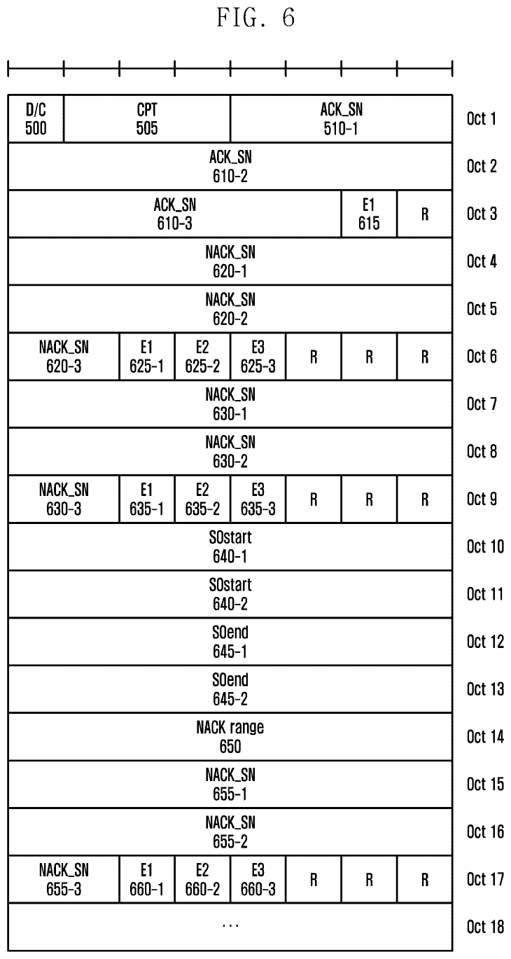

FIG. 6 illustrates an example of a format of an RLC STATUS PDU when the length of an RLC sequence number (SN) is 18 bits, according to an embodiment of the disclosure.

Referring to FIGS. 5 and 6, each field may have the following meanings.
Data/Control (D/C) 500 and 600 field: It may indicate whether the corresponding RLC PDU is an RLC data PDU or an RLC control PDU. For example, if a value of the corresponding field is 0, it may indicate an RLC control PDU. For example, if a value of the corresponding field is 1, it may indicate an RLC data PDU. For example, an RLC STATUS PDU may belong to an RLC control PDU.
Control PDU Type (CPT) 505 and 605 field: It may indicate the type of RLC control PDU. A STATUS PDU may be indicated by a specific CPT field value (e.g., 000).
ACK_SN 510-1 and 510-2, and 610-1, 610-2, and 610-3: The length of an ACK_SN field may be configured to one of 12 bits 510-1 and 510-2 or 18 bits 610-1, 610-2, and 610-3. When configured to 12 bits, the RLC STATUS PDU may have a format shown in FIG. 5, and when configured to 18 bits, the RLC STATUS PDU may have a format shown in FIG. 6. The ACK_SN field may indicate an SN of the next unreceived RLC SDU which has not been reported as missing in the STATUS PDU. When a transmitting side of an AM RLC layer device receives the STATUS PDU, it may be interpreted that all RLC SDUs up to an RLC SDU with SN=ACK_SN (excluding ACK_SN), except for the following RLC SDU(s)/a portion of the RLC SDU(s), have been received by a peer AM RLC layer device. The excluded RLC SDU(s)/portion of the RLC SDU(s) may include the following cases.
RLC SDU(s) indicated by NACK_SN in the STATUS PDU
Portion of an RLC SDU indicated by NACK_SN, SOstart, and SOend in the STATUS PDU
RLC SDU(s) indicated by NACK_SN and NACK range in the STATUS PDU
Portion of RLC SDU(s) indicated by NACK_SN, NACK range, SOstart, and SOend in the STATUS PDU
Extension bit 1 (E1) 515, 525-1, 535-1, 560-1, 615, 625-1, 635-1, and 660-1 field: It may indicate whether a set of NACK_SN, E1, E2, and E3 follows. For example, if a value of the corresponding field is 0, it may indicate that the set of NACK_SN, E1, E2, and E3 does not follow. For example, if the value of the corresponding field is 1, it may indicate that the set of NACK_SN, E1, E2, and E3 follows.
Extension bit 2 (E2) 525-2, 535-2, 560-2, 625-2, 635-2, and 660-2: It may indicate whether a set of SOstart and SOend follows. For example, a value of 0 in the corresponding field may indicate that SOstart and SOend do not follow, and a value of 1 in the corresponding field may indicate that SOstart and SOend follow.
Extension bit 3 (E3) 525-3, 535-3, 560-3, 625-3, 635-3, and 660-3 field: It may indicate whether information on RLC SDU(s) which have not been consecutively received follows. For example, a value of 0 in the corresponding field may indicate that a NACK range field does not follow the corresponding NACK_SN, and a value of 1 in the corresponding field may indicate that a NACK range field follows the corresponding NACK_SN.
Negative Acknowledgement SN (NACK_SN) 520-1 and 520-2, 530-1 and 530-2, 555-1 and 555-2, 620-1, 620-2, and 620-3, 630-1, 630-2, and 630-3, and 655-1, 655-2, and 655-3 field: It may indicate an SN of an RLC SDU (or RLC SDU segment) which has been detected as lost on a receiving side of the AM RLC layer device. The length of the corresponding field may be configured to 12 bits (e.g., FIG. 5) or 18 bits (e.g., FIG. 6).
SO start (SOstart) 540-1 and 540-2, and 640-1 and 640-2: An SOstart field (together with an SOend field) may indicate a portion of an RLC SDU with SN=NACK_SN (NACK_SN associated with SOstart) which has been detected as lost on the receiving side of the AM RLC layer device. For example, the SOstart field may indicate the position of a first byte of a portion of an RLC SDU to be indicated within the corresponding RLC SDU. The first byte of the RLC SDU may be indicated by an SOstart field value of “0000000000000000.” That is, the position may start from 0.
SO end (SOend) 545-1 and 545-2, and 645-1 and 645-2: When E3 is 0, the SOend field (together with the SOstart field) may indicate a portion of an RLC SDU with SN=NACK_SN (NACK_SN associated with SOend) which has been detected as lost on the receiving side of the AM RLC layer device. For example, the SOend field may indicate the position of the last byte of a portion of the indicated RLC SDU within the corresponding RLC SDU. For example, a first byte of the corresponding RLC SDU may be indicated by an SOend field value of “0000000000000000.” That is, the position may start from 0. A special SOend value of “11111111111111111” may be used to indicate that the missing portion of the RLC SDU includes all bytes up to the last byte of the corresponding RLC SDU. For example, when E3 is 1, the SOend field may indicate a portion of the RLC SDU with SN=NACK_SN+NACK range−1 which has been detected as lost on the receiving side of the AM RLC layer device. For example, the SOend field may indicate the position of the last byte of a portion of the indicated RLC SDU within the corresponding RLC SDU. For example, the first byte of the corresponding RLC SDU may be indicated by an SOend field value of “0000000000000000.” That is, the position may start from 0. A special SOend value of “11111111111111111” may be used to indicate that the missing portion of the RLC SDU includes all bytes up to the last byte of the corresponding RLC SDU.
NACK range field 550 and 650: It may indicate the number of consecutively lost RLC SDUs starting from (and including) the corresponding NACK_SN. For example, the length of the corresponding field may be 8 bits.

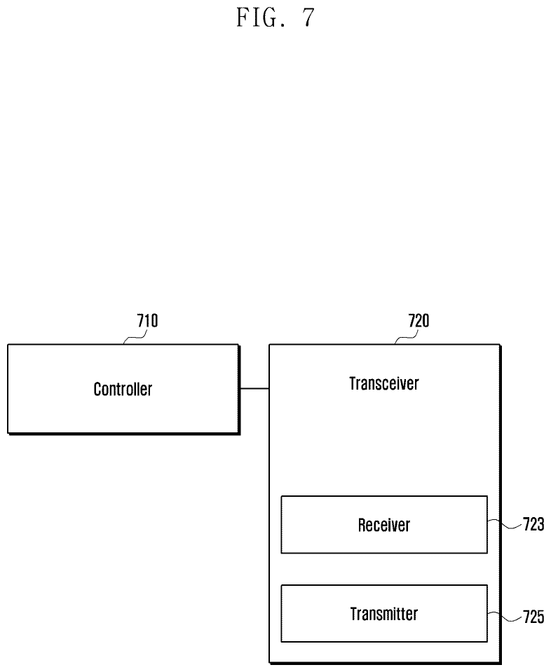

FIG. 7 illustrates an example of a structure of a UE according to an embodiment of the disclosure.

Referring to FIG. 7, the UE according to an embodiment of the disclosure may include a transceiver 720 and a controller 710 that controls the overall operation of the UE. Also, the transceiver 720 may include a transmitter 725 and a receiver 723.

The transceiver 720 may transmit/receive signals with other network entities.

The controller 710 may control the UE to perform the operations according to any one of the above-described embodiments. Of course, the controller 710 and the transceiver 720 are not necessarily implemented as separate modules, but may be implemented as a single component unit such as a single chip. Also, the controller 710 and the transceiver 720 may be electrically connected to each other. In addition, the controller 710 may be, for example, a circuit, an application-specific circuit, or at least one processor. Moreover, the operations of the UE may be implemented by providing any unit in the UE with a memory device storing corresponding program codes.

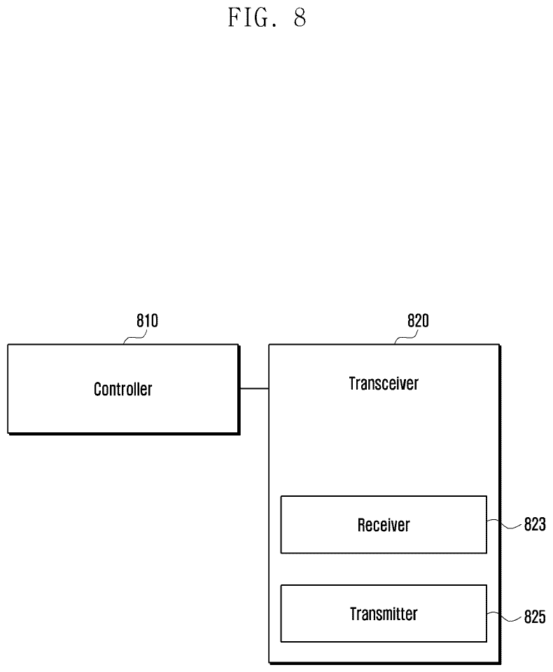

FIG. 8 illustrates an example of a structure of a base station according to an embodiment of the disclosure.

Referring to FIG. 8, the base station according to an embodiment of the disclosure may include a transceiver 820 and a controller 810 that controls the overall operation of the base station. Also, the transceiver 820 may include a transmitter 825 and a receiver 823.

The transceiver 820 may transmit/receive signals with UEs or other network entities.

The controller 810 may control the base station to perform the operations according to any one of the above-described embodiments. Of course, the controller 819 and the transceiver 820 are not necessarily implemented as separate modules, but may be implemented as a single component unit such as a single chip. Also, the controller 810 and the transceiver 820 may be electrically connected to each other. In addition, the controller 810 may be, for example, a circuit, an application-specific circuit, or at least one processor. Moreover, the operations of the base station may be implemented by providing any unit in the base station with a memory device storing corresponding program codes.

The embodiments of the disclosure described and shown in the specification and the drawings are merely particular examples that have been presented to easily explain the technical contents of the disclosure and help understanding of the disclosure, and are not intended to limit the scope of the disclosure. That is, it will be apparent to those skilled in the art that other variants based on the technical idea of the disclosure may be implemented. Also, the above respective embodiments may be employed in combination, as necessary. For example, the respective embodiments of the disclosure may be at least partially combined with each other to be operated by a base station, a terminal, or a specific network entity.

Methods disclosed in the claims and/or methods according to the embodiments described in the specification of the disclosure may be implemented by hardware, software, or a combination of hardware and software.

When the methods are implemented by software, a computer-readable storage medium for storing one or more programs (software modules) may be provided. The one or more programs stored in the computer-readable storage medium may be configured for execution by one or more processors within the electronic device. The at least one program includes instructions that cause the electronic device to perform the methods according to various embodiments of the disclosure as defined by the appended claims and/or disclosed herein.

These programs (software modules or software) may be stored in non-volatile memories including a random access memory and a flash memory, a read only memory (ROM), an electrically erasable programmable read only memory (EEPROM), a magnetic disc storage device, a compact disc-ROM (CD-ROM), digital versatile discs (DVDs), or other type optical storage devices, or a magnetic cassette. Alternatively, any combination of some or all of them may form a memory in which the program is stored. In addition, a plurality of such memories may be included in the electronic device.

Furthermore, the programs may be stored in an attachable storage device which can access the electronic device through communication networks such as the Internet, Intranet, local area network (LAN), wide LAN (WLAN), and storage area network (SAN) or a combination thereof. Such a storage device may access the electronic device via an external port. Also, a separate storage device on the communication network may access a portable electronic device.

In the above-described detailed embodiments of the disclosure, an element included in the disclosure is expressed in the singular or the plural according to presented detailed embodiments. However, the singular form or plural form is selected appropriately to the presented situation for the convenience of description, and the disclosure is not limited by elements expressed in the singular or the plural. Therefore, either an element expressed in the plural may also include a single element or an element expressed in the singular may also include multiple elements.

It should be noted that the configuration diagrams, illustrative diagrams of control/data signal transmission methods, illustrative diagrams of operation procedures, and structural diagrams as illustrated in FIG. 1 to FIG. 8 are not intended to limit the scope of protection of the disclosure. That is, all the constituent units, entities, or operation steps shown in FIG. 1 to FIG. 8 should not be construed as essential elements for implementing the disclosure, and even when including only some of the elements, the disclosure may be implemented without impairing the true nature of the disclosure.

The above-described operations of a base station or a terminal may be implemented by providing a memory device storing corresponding program codes in a base station or terminal device. That is, a controller of the base station or terminal device may perform the above-described operations by reading and executing the program codes stored in the memory device by means of a processor or central processing unit (CPU).

Various units or modules of a network entity, a base station device, or a terminal device may be operated using hardware circuits such as complementary metal oxide semiconductor-based logic circuits, firmware, or hardware circuits such as combinations of software and/or hardware and firmware and/or software embedded in a machine-readable medium. For example, various electrical structures and methods may be implemented using transistors, logic gates, and electrical circuits such as application-specific integrated circuits.

Although specific embodiments have been described in the detailed description of the disclosure, it will be apparent that various modifications and changes may be made thereto without departing from the scope of the disclosure. Therefore, the scope of the disclosure should not be defined as being limited to the embodiments set forth herein, but should be defined by the appended claims and equivalents thereof.

Although the present disclosure has been described with various embodiments, various changes and modifications may be suggested to one skilled in the art. It is intended that the present disclosure encompass such changes and modifications as fall within the scope of the appended claims.

What is claimed is:

1. A method performed by a terminal in a wireless communication system, the method comprising:
receiving, from a base station, a message comprising information on a timer for a radio link control (RLC) service data unit (SDU) discard at an RLC entity of the terminal;
receiving, from the base station, an acknowledged mode (AM) data (AMD) protocol data unit (PDU) with a sequence number (SN) x;
in case that at least one of RX_Next_Highest is greater than RX_Next+1, or the RX_Next_Highest is equal to the RX_Next+1 and there is at least one missing byte segment of a RLC SDU associated with SN=RX_Next before a last byte of all received segments of the RLC SDU, starting the timer; and
in case that the timer expires, discarding at least one AMD PDU in a buffer with SN lower than x+1,
wherein the RX_Next holds a value of an SN following a last in-sequence completely received RLC SDU, and
wherein the RX_Next_Highest holds a value of an SN following an SN of an RLC SDU with a highest SN among received RLC SDUs.

2. The method of claim 1, further comprising:
in case that the timer is running, determining at least one of whether RX_Next_Discard_Trigger is equal to RX_Next, whether the RX_Next_Discard_Trigger is equal to RX_Next+1 and there is no missing byte segment of an RLC SDU associated with an SN=RX_Next before a last byte of all received segments of the RLC SDU, or whether the RX_Next_Discard_Trigger falls outside of a receiving window and the RX_Next_Discard_Trigger is not equal to RX_Next+AM_Window_Size; and
in case that at least one of the RX_Next_Discard_Trigger is equal to the RX_Next, the RX_Next_Discard_Trigger is equal to RX_Next+1 and there is no missing byte segment of an RLC SDU associated with an SN =RX_Next before a last byte of all received segments of the RLC SDU, or the RX_Next_Discard_Trigger falls outside of a receiving window and the RX_Next_Discard_Trigger is not equal to RX_Next+AM_Window_Size, stopping the timer and resetting the timer,
wherein the RX_Next_Discard_Trigger holds a value of an SN following an SN of an RLC SDU which triggered the timer, and
wherein the AM_Window_Size is a receiving window size.

3. The method of claim 1, further comprising:
in case that the timer expires and the at least one AMD PDU is discarded, triggering a status report.

4. The method of claim 1, wherein the starting the timer further comprises:
in case that x is greater than or equal to the RX_Next_Highest, updating RX_Next_Highest to x+1.

5. The method of claim 1, wherein the starting the timer further comprises:
setting RX_Next_Discard_Trigger to the RX_Next_Highest,
wherein the RX_Next_Discard_Trigger holds a value of an SN following an SN of an RLC SDU which triggered the timer.

6. The method of claim 5, wherein the discarding the at least one AMD PDU comprises:
updating the RX_Next to an SN of a first RLC SDU with SN>=RX_Next_Discard_Trigger for which not all bytes have been received; and
discarding the at least one AMD PDU in the buffer with SN<RX_Next_Discard_Trigger.

7. The method of claim 1, wherein the information on the timer is included in RLC configuration information.

8. A terminal in a wireless communication system, the terminal comprising:
a transceiver; and
a controller configured to:
receive, from a base station via the transceiver, a message comprising information on a timer for a radio link control (RLC) service data unit (SDU) discard at an RLC entity of the terminal,
receive, from the base station via the transceiver, an acknowledged mode (AM) data (AMD) protocol data unit (PDU) with a sequence number (SN) x,
in case that at least one of RX_Next_Highest is greater than RX_Next+1, or the RX_Next_Highest is equal to the RX_Next+1 and there is at least one missing byte segment of a RLC SDU associated with SN=RX_Next before a last byte of all received segments of the RLC SDU, start the timer, and
in case that the timer expires, discard at least one AMD PDU in a buffer with SN lower than x+1,
wherein the RX_Next holds a value of an SN following a last in-sequence completely received RLC SDU, and
wherein the RX_Next_Highest holds a value of an SN following an SN of an RLC SDU with a highest SN among received RLC SDUs.

9. The terminal of claim 8, wherein the controller is configured to:
in case that the timer is running, determine at least one of whether RX_Next_Discard_Trigger is equal to RX_Next, whether the RX_Next_Discard_Trigger is equal to RX_Next+1 and there is no missing byte segment of an RLC SDU associated with an SN=RX_Next before a last byte of all received segments of the RLC SDU, or whether the RX_Next_Discard_Trigger falls outside of a receiving window and the RX_Next_Discard_Trigger is not equal to RX_Next +AM_Window_Size, and
in case that at least one of the RX_Next_Discard_Trigger is equal to the RX_Next, the RX_Next_Discard_Trigger is equal to RX_Next+1 and there is no missing byte segment of an RLC SDU associated with an SN=RX_Next before a last byte of all received segments of the RLC SDU, or the RX_Next_Discard_Trigger falls outside of a receiving window and the RX_Next_Discard_Trigger is not equal to RX_Next+AM_Window_Size, stop the timer and reset the timer,
wherein the RX_Next_Discard_Trigger holds a value of an SN following an SN of an RLC SDU which triggered the timer, and
wherein the AM_Window_Size is a receiving window size.

10. The terminal of claim 8, wherein the controller is configured to:
in case that the timer expires and the at least one AMD PDU is discarded, trigger a status report.

11. The terminal of claim 8, wherein the controller is further configured to:
in case that x is greater than or equal to the RX_Next_Highest, update RX_Next_Highest to x+1.

12. The terminal of claim 8, wherein the controller is configured to:
set RX_Next_Discard_Trigger to the RX_Next_Highest, and
wherein the RX_Next_Discard_Trigger holds a value of an SN following an SN of an RLC SDU which triggered the timer.

13. The terminal of claim 12, wherein the controller is configured to:
update the RX_Next to an SN of a first RLC SDU with SN>=RX_Next_Discard_Trigger for which not all bytes have been received, and
discard the at least one AMD PDU in the buffer with SN<RX_Next_Discard_Trigger.

14. The terminal of claim 8, wherein the information on the timer is included in RLC configuration information.
